(19) United States
(12) Patent Application Publication
(10) Pub. No.: US 2010/0220207 A1
(43) Pub. Date: Sep. 2, 2010

(54) IMAGE EDITING APPARATUS, IMAGE CAPTURING APPARATUS AND MEDIUM STORING IMAGE EDITING PROGRAM

(75) Inventor: Taro MAKIGAKI, Yokohama-shi (JP)

Correspondence Address: OLIFF & BERRIDGE, PLC, P.O. BOX 320850, ALEXANDRIA, VA, 22320-4850, US

(73) Assignee: NIKON CORPORATION, Tokyo (JP)

(21) Appl. No.: 12/702,840

(22) Filed: Feb. 9, 2010

(30) Foreign Application Priority Data
Feb. 18, 2009 (JP) 2009-035647

(51) Int. Cl. H04N 5/93; H04N 5/228

(52) U.S. Cl. 348/222.1; 386/52; 386/E05.003; 348/E05.031

(57) ABSTRACT

An image editing apparatus includes a selecting unit, an accepting unit, an extracting unit, and a calculating unit. The selecting unit selects any frame from a plurality of frames forming a moving image to be edited according to an instruction from a user. The accepting unit accepts designation of the user regarding an area to be edited and editing content for the any frame. The extracting unit extracts the area to be edited for each of the frames forming the moving image. For each of the frames forming the moving image, the calculating unit calculates a control value to be used for editing the area in each frame based on a difference between previously or subsequently continuing frames and the editing content or based on a result of editing provided to the any frame according to the editing content.

### CROSS REFERENCE TO RELATED APPLICATION

This application is based upon and claims the benefit of priority from Japanese Patent Application No. 2009-035647, filed on Feb. 18, 2009, the entire contents of which are incorporated herein by reference.

### BACKGROUND

1. Field

The present application relates to an image editing apparatus editing a moving image, an imaging capturing apparatus capturing an object image and generating a moving image, and an image editing program obtaining the editing of a moving image by a computer.

2. Description of the Related Art

Conventionally, there have been devised various techniques for editing a moving image. For example, by employing an extraction method of a specific object of image capturing, which is disclosed in Japanese Unexamined Patent Application Publication No. H09-134418, for editing a moving image, it is possible to achieve efficient editing in consideration of a sequentially changing object of image capturing.

Meanwhile, the moving image includes a plurality of frames. Accordingly, a user needs to designate an editing area and designate editing contents for each of the plurality of frames and there is a problem that the designations are time-consuming and troublesome.

### SUMMARY

Accordingly, a proposition of the present application is to alleviate the burden of the moving image editing and to achieve preferable editing by a simple operation.

An image editing apparatus according to an aspect of embodiment includes a selecting unit selecting any frame among a plurality of frames forming a moving image to be edited according to an instruction from a user, an accepting unit accepting designation of the user regarding an area to be edited and editing content for the any frame, an extracting unit extracting the area to be edited for each of the frames forming the moving image, and a calculating unit calculating a control value to be used for editing the area in each frame based on a difference between previously or subsequently continuing frames and the editing content, for each of the frames forming the moving image. Alternatively, instead of the above calculating unit, the image editing apparatus includes a calculating unit calculating, for each of the frames forming the moving image, a control value to be used for editing the area in each frame based on a result of editing provided to the any frame according to the editing content.

The image editing apparatus according to the aspect of embodiment described above may further include an obtaining unit obtaining an image capturing condition at the time of image capturing of the moving image, in which the calculating unit calculates the control value by taking the image capturing condition into account.

The image editing apparatus according to the aspect of embodiment described above may further include a detecting unit detecting a gradient of a main object in the moving image, in which the extracting unit extracts the area by taking the gradient into account.

The image editing apparatus according to the aspect of embodiment described above may further include an editing unit editing each of the frames forming the moving image according to the control value calculated by the calculating unit.

Note that an image capturing apparatus including any of the above image editing apparatuses and an imaging capturing unit, which captures an image of the object and generating the moving image, is also effective as a specific aspect of the present embodiment, in which the selecting unit selects any frame among the plurality of frames forming the moving image generated by the image capturing unit, the extracting unit extracts the area to be edited for each of the frames forming the moving image generated by the image capturing unit, and the calculating unit calculates the control value for each of the frames forming the moving image generated by the image capturing unit.

Further, a medium storing an image editing program that is a program for obtaining image editing of a moving image to be edited and corresponds to any of the above image editing apparatus configurations, is also effective as a specific aspect of the present embodiment.

### BRIEF DESCRIPTION OF THE DRAWINGS

Note that the other propositions and features and advantages of the present application will be apparent in the following explanation.

FIG. 1 is a block diagram showing a configuration for an image editing apparatus 1 of the present embodiment.

FIG. 2 is a flowchart showing an operation of a control unit 16.

FIG. 3 is an exemplary diagram explaining the calculation of a control value.

FIG. 4 is a block diagram showing a configuration of an electronic camera 100 of the present embodiment.

### DETAILED DESCRIPTION OF THE EMBODIMENTS

Hereinafter, an embodiment of the present invention will be explained by the use of the drawings.

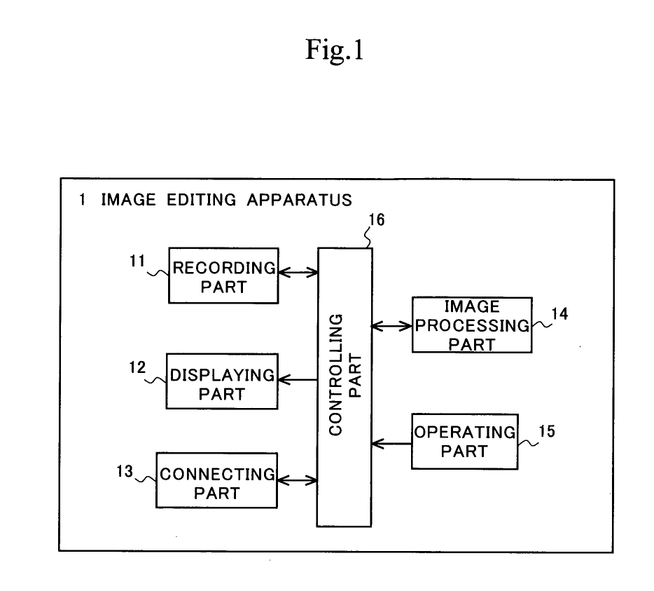

FIG. 1 is a block diagram of a configuration for an image editing apparatus of the present embodiment. The image editing apparatus of the present embodiment is configured with a computer and the like. As shown in FIG. 1, the image editing apparatus 1 includes: a recording unit 11 recording data such as an image; a displaying unit 12 which has a displaying element such as a monitor and displays an image, various menus, and the like; a connecting unit 13 which has a connecting terminal such as a USB and interconnected with an external device such as an electronic camera and a printer; an image processing unit 14 providing image processing to the image or the like recorded in the recording unit 11; and an operating unit 15 which has an operating member such as a mouse and a keyboard and accepts various instructions from a user, and also has a controlling unit 16 controlling each of the units collectively. Each of the recording unit 11, the connecting unit 13, and the image processing unit 14 is interconnected with the controlling unit 16. Further, an output of the controlling unit 16 is connected to the displaying unit 12. Moreover, the controlling unit 16 detects an operation state of the operating unit 15 and also records in advance a program for controlling each of the units.

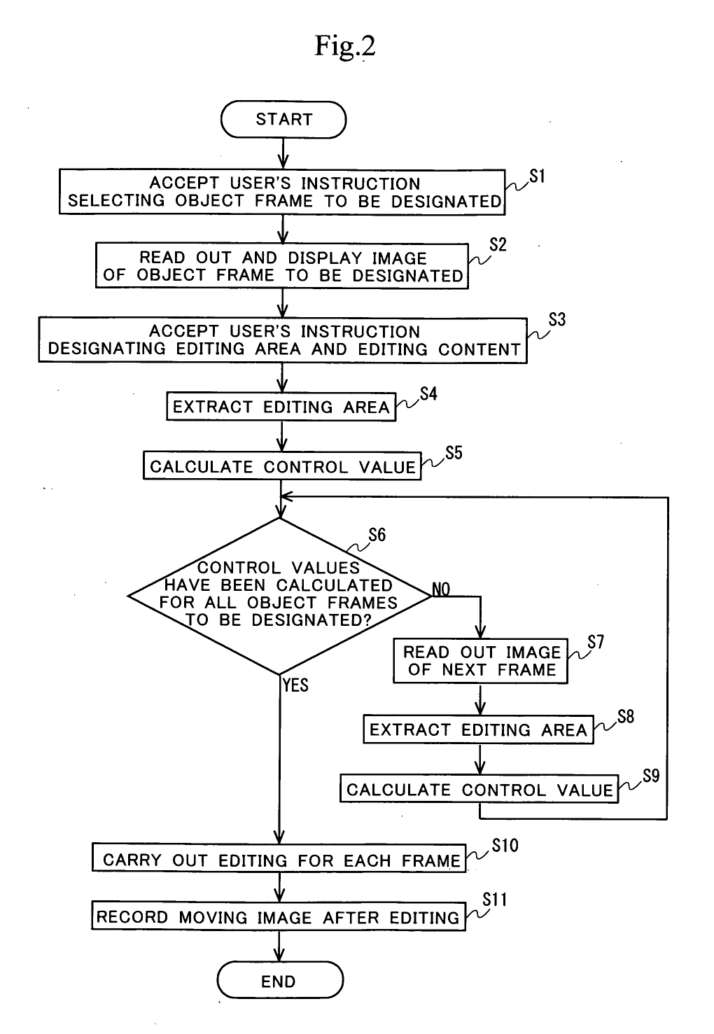

In the image editing apparatus 1 configured as explained above, the operation of the control unit 16 for editing a moving image recorded in the recording unit 11 will be explained with reference to a flowchart shown in FIG. 2. Note that, in the editing of the moving image, the moving image to be edited is selected in advance from the moving images recorded in the recording unit 11 by a user operation via the operating unit 15.

In Step S1, the controlling unit 16 accepts a user's instruction selecting an editing object frame to be designated. The editing object frame to be designated is an object frame to which a user provides designation regarding the editing among a plurality of frames forming the moving image to be edited. The user selects the object frame to be designated by operating the operating unit 15.

Note that the selection of the object frame to be designated may be carried out during the reproduction of the moving image. For example, when the user confirms the deterioration or the failure of the moving image during the reproduction, the frame at that point may be selected as the object frame to be designated.

In Step S2, the controlling unit 16 reads out the image of the object frame to be designated selected in Step 1 and displays the image on the displaying unit 12.

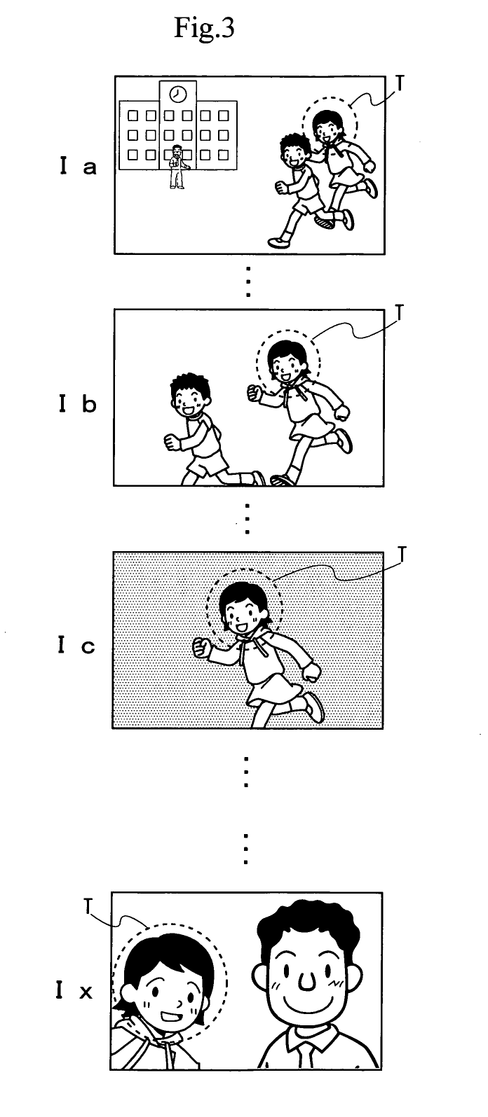

In Step S3, the controlling unit 16 accepts a user's instruction designating an editing area and editing contents via the operating unit 15. The editing area is a specific area to be subjected to editing. For example, when a plurality of persons are included in an object of image capturing as shown in FIG. 3, the user can designate a local area such as a specific person or a face part of the person as an object of the editing. Note that the designation of the editing area may be performed by any method. For example, the designation may be performed by typical area selection or may be performed by a designation method in which a point (so-called control point) is selected and a predetermined peripheral area is determined to be the editing area. Further, the size and the shape of the area at the time of the area designation may also be optional. Moreover, a whole image may be designated as the editing area.

Next, the editing contents are contents of image processing provided to the above editing area. The image processing includes processing such as exposure correction, brightness adjustment, gradation compression, edge enhancement, noise rejection, color processing, and white balance adjustment. Further, the editing contents also include gradient adjustment of the image.

Moreover, the editing contents include a temporal editing range. The user designates whether to set all the frames forming the moving image to be edited for an object of the editing or to set only a part of the frames for an object of the editing, and, when a part of the frames is set for the object of the editing, the user also designates the first and last frames or designates any frame to be edited.

In Step S4, the controlling unit 16 extracts the editing area designated in Step S3 from the images read out in Step S2. The controlling unit 16 extracts the editing area designated in Step S3 from the images read out in Step S2 by existing methods such as object recognition, face recognition, and template matching.

In Step S5, the controlling unit 16 calculates a control value. The controlling unit 16 calculates each of the control values according to the respective editing contents designated in Step 3 as in a publicly known technique. Note that, when the editing contents designated in Step 3 include the gradient adjustment of the image, and also the moving image to be edited has information on the gradient at the time of the image capturing, the controlling unit 16 calculates the control value by taking this information into account.

In Step S6, the controlling unit 16 determines whether the control values have been calculated for all the frames to be edited, designated in Step 3. Then, if the control values are determined to have been calculated for all the frames to be edited, the process goes to Step S10 to be described hereinafter. On the other hand, if the control values are determined not to have been calculated for all the frames to be edited, the controlling unit 16 goes to Step 7.

In Step S7, the controlling unit 16 reads out the image of the next frame to be edited. At this time, the controlling unit 16 may display the read-out image on the displaying unit 12 as in Step S2.

In Step S8, the controlling unit 16 extracts the editing area designated in Step S3 from the images read out in Step 7. The controlling unit 16 extracts the editing area designated in Step S3 from the image read out in Step S7 by existing methods such as object recognition, face recognition, and template matching as in Step S4. At this time, the controlling unit 16 may extract the editing area by referring to the extraction result of the last time (extraction result of the frame subjected to the previous extraction). That is, the extraction of the editing area may be performed by processing similar to tracking. Further, when the moving image to be edited has the information such as a lens focal distance and an object distance as the image capturing condition at the time of the image capturing, the controlling unit 16 may perform the editing area extraction by taking this information into account. Moreover, when the moving image to be edited has the gradient information at the time of the image capturing, the controlling unit 16 may perform the editing area extraction by taking this information into account.

In Step S9, the controlling unit 16 calculates the control value.

The controlling unit 16 calculates the control value to be used for editing of the frame read out in Step S7 by any of the following methods (1) to (3). Then, after having calculated the control value, the controlling unit 16 returns to Step S6.

(1) Calculating Method Based on a Difference Between a Current Frame and a Continuing Frame

The controlling unit 16 first obtains a difference between a current frame and the frame for which the control value has been calculated last time. Then, by using this difference and the control value calculated last time, the controlling unit 16 calculates the control value so as to obtain a result equivalent to the result of the editing provided to the image of the object frame to be designated selected in Step S1 according to the editing content designated in Step S3, in the editing area extracted in Step S8, as the control value for the editing in the editing area extracted in Step S8.

Further, when the moving image to be edited has the information such as a lens focal distance and an object distance as the image capturing condition at the time of the image capturing, the controlling unit 16 may calculate the control value by taking this information into account. Moreover, when the moving image to be edited has the gradient information at the time of the image capturing, the controlling unit 16 may calculate the control value by taking this information into account.

For example, when a face part of a person is designated as the editing area and exposure correction of the editing area is designated as the editing content in Step S3, and when the obtained difference is presumed to cause the current frame to be overexposed, the controlling unit 16 determines the control value for the exposure correction of the current frame to be weaker according to the extent thereof. Adversely, when the obtained difference is presumed to cause the current frame to be underexposed, the controlling unit 16 determines the control value for the exposure correction of the current frame to be stronger according to the extent thereof. Further, the controlling unit 16 may obtain a field angle from the image capturing condition and calculate the control value for the exposure correction according to the change of the field angle. The control value for the brightness adjustment is also calculated in a similarly manner.

Further, when a part such as a flower or an insect for which edge enhancement or noise rejection is effective is designated as the editing area and the edge enhancement or the noise rejection of the editing area is designated as the editing content, for example, in Step S3, and when the obtained difference is presumed to cause the current frame to have stronger edge enhancement, the controlling unit 16 determines the control value for the edge enhancement of the current frame to be weaker according to the extent thereof. Adversely, when the obtained difference is presumed to cause the current frame to have weaker edge enhancement, the controlling unit 16 determines the control value for the edge enhancement of the current frame to be stronger according to the extent thereof. Further, the controlling unit 16 may obtain a lens defocusing amount from the image, capturing condition and calculate the control value for the edge enhancement according to the change of the field angle. Moreover, the controlling unit 16 may obtain the change of MTF according to the image capturing condition and calculate the control value for the edge enhancement or the noise rejection according to this change. In addition, when the image capturing condition includes the sensitivity of the image capturing element, the controlling unit 16 may calculate the control value for the noise rejection according to the sensitivity of the image capturing element. For example, when the image capturing has a high sensitivity, the controlling unit 16 may determine the control value for the edge enhancement to be weaker so as not to enhance the noise unnecessarily.

Further, when a face part of a person is designated as the editing area and the color processing providing a red tinge to make a healthy skin color is designated for the editing content of the color processing for the editing area, for example, in Step S3, and when the obtained difference is presumed to cause the color representation of the current frame to be tinged with red by the white balance adjustment, the controlling unit 16 determines the control value for the color processing of the current frame to be weaker according to the extent thereof. Adversely, when the obtained difference is presumed to cause the color representation of the current frame to be weaker in a red tinge, the controlling unit 16 determines the control value for the color processing of the current frame to be stronger according to the extent thereof.

Further, when gradient adjustment of the image is designated as the editing content, for example, in Step S3, the controlling unit 16 estimates the image gradient in the editing area of the current frame and calculates the control value for the gradient adjustment of the current frame according to the extent thereof. At this time, when the moving image to be edited has the gradient information or the like at the time of the image capturing, the controlling unit 16 may calculate the control value for the gradient adjustment by taking this information into account.

(2) Calculating Method Based on a Result of Editing Provided to the Image Read Out in Step S2 According to the Editing Contents Received in Step S3

The controlling unit 16 first calculates a target value for each of the control values corresponding to the respective editing contents designated in Step S3 based on a result of editing provided to the editing area designated in Step S3 in the image read out in Step S2 according to the editing content accepted in Step S3. Then, the controlling unit 16 calculates the control value achieving the target value based on this target value and an image of the editing area extracted in Step S8 in the image read out in Step S7. The calculated control value is the one to be used at the time of the editing of the editing area extracted in Step S8 and the one to provide a result equivalent to the result of the editing provided to the object frame to be designated selected in Step S1 according to the editing content designated in Step S3, in the editing area extracted in Step S8.

Further, when the moving image to be edited has the information such as a lens focal distance and an object distance as the image capturing condition at the time of the image capturing, the controlling unit 16 may calculate the control value by taking this information into account. Moreover, when the moving image to be edited has the gradient information or the like at the time of the image capturing, the controlling unit 16 may calculate the control value by taking this information into account.

(3) Calculating Method Combining the Above Methods (1) and (2)

The controlling unit 16 calculates the control values by the above methods (1) and (2), respectively, and calculates a control value by adding the two control values weighted as needed.

In Step S6, after determining that the control values have been calculated for all the frames to be edited designated in Step S3, the controlling unit 16 carries out editing of each of the frames forming the moving image in Step S10. The controlling unit 16 controls the image processing unit 14 and carries out editing of each of the frames to be edited designated in Step S3 using the control value of the frame calculated in Step S5 or Step S9.

In Step S11, the controlling init 16 records the moving image after the editing in Step S10 in the recording unit 11 and terminates the series of processes. At this time, the controlling unit 16 may record the whole moving image or may record only the frames edited in Step S10.

By carrying out each of the above explained processing, it is possible to calculate the control value to be used for editing the area to be edited in each of the frames. For example, as shown in FIG. 3, when a plurality of frames Ia to In are determined to be edited, the frame Ia is selected in Step S1 as the object frame to be designated, and an area T is designated in Step S3 as the editing area, it is possible to extract the editing area in each of the frames and calculate the preferable control value in the editing area, even when the editing area moves and changes the shape thereof, and environment such as the brightness changes among the frames Ib to In.

As explained above, the present embodiment selects any frame among the plurality of frames forming the moving image to be edited by a user's instruction and accepts a user's designation regarding the area to be edited and the editing contents for the selected any frame. Then, the present embodiment extracts the area to be edited for each of the frames forming the moving image, and also calculates the control value to be used for the editing of the area to be edited in each frame based on a difference between previously or subsequently continuing frames and the editing content for each of the frames forming the moving image. Accordingly, the user needs not carry out the designation regarding the editing for each of the plurality of frames forming the moving image and can calculate the preferable control value for each of the plurality of frames only by carrying out the designation regarding the editing of the any frame. Further, the calculated control value reflects the user's designation and thereby user's preference or purpose can be grasped. Accordingly, it is possible to reduce the burden of the moving image editing and to achieve a preferable editing by a simple operation.

Further, the present embodiment calculates the control value to be used for the editing of the area to be edited in each of the frames based on the result of the editing provided to the selected any frame according to the designated editing content for each of the frames forming the moving image. Accordingly, it is possible to obtain the above described effect by a simpler method.

Moreover, the present embodiment obtains the image capturing condition at the time of the image capturing of the moving image and calculates the control value by taking the obtained image capturing condition into account. Accordingly, it is possible to calculate the more preferable control value for each of the plurality of frames.

In addition, the present embodiment detects the gradient of a main object in the moving image, and extracts the area to be edited and calculates the control value by taking the detected gradient into account. Accordingly, it is possible to obtain the extraction of the areas and the calculation of the control values according to the gradients of the plurality of frames, respectively.

Note that, while the present embodiment explains an example for the case of performing the editing for each of the plural frames based on the calculated control value, there may be a configuration in which the calculated value may be recorded in association with each of the plural frames and the editing may be performed at other timing.

Further, the editing area(s) may be designated at one position or plural positions in Step S3 of the present embodiment. When the plural positions areas are designated as the editing areas, each of the editing areas may be subjected to the same processing as the above described processing. Note that, when it is difficult to take a balance among the plural positions, a priority order may be set as needed and the processing may be carried out in the priority order.

Further, although Step S3 of the present embodiment explains an example for the case in which it is designated whether all the frames forming the moving image to be edited are the object of the frame editing or only a part of the frames is the object of the editing for the temporal editing range, the present invention is not limited to this example. For example, there may be a configuration in which the object frame to be designated selected in Step S1 is set to be a reference and only the subsequent frames are determined to be the object of the editing, or there may be a configuration in which only the previous frames are determined to be the object of the editing.

Further, when the control value is calculated in Step S5 or Step S7 of the present embodiment, the control value may be configured to have an upper limit or a lower limit. By such a configuration, it is possible to prevent unnatural editing by the extreme control value. Such a setting of the upper limit or the lower limit is especially effective in the exposure correction, the color correction, the gradient adjustment, etc. Further, when the control value exceeds the upper limit or the lower limit, there may be a configuration in which the control value is not calculated but a predetermined control value is used, a configuration in which the control value is calculated by another calculation method, or a configuration in which a user is notified. Moreover, there may be a configuration in which the user can select whether or not to set the upper limit or the lower limit.

Further, in the calculation of the control value in Step S5 or Step S7 of the present embodiment, the control value may be determined so as to change gradually at a boundary part between the editing area and the other area. By such a configuration, it is possible to suppress an uncomfortable feeling caused at the boundary part between the editing area and the other area in the image after the editing.

Further, in the calculation of the control value in Step S7 of the present embodiment, the control value may be determined so as to change gradually at the first and the last of the temporal range designated in Step S3. By such a configuration, it is possible to suppress an uncomfortable feeling caused at the first and the last of the temporal range in the moving image after the editing.

Further, when the editing area cannot be extracted in Step S8 of the present embodiment, the process may be configured to skip Step S9 and to return to Step S6. In addition, the user may be notified by the use of the displaying unit 12 or the like that the editing area cannot be extracted.

Further, in the present embodiment, the moving image to be edited may be any. For example, the moving image to be edited may be one that is made up of information of all the frames, or may be one that is made up of reference image information and difference information.

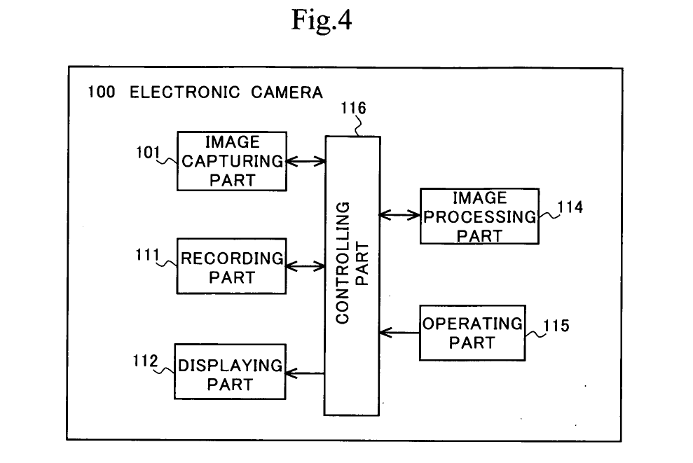

Further, although the present embodiment explains an example of the image editing apparatus 1 which includes a computer and the like, the present invention is not limited to this example. For example, an electronic camera provided with this image editing apparatus is effective as a specific aspect of the present invention. For example, as shown in FIG. 4, the present invention can be similarly applied to the electronic camera 100 provided with: an image capturing unit 101 which has an image capturing element (not shown in the drawing) and generates a moving image; a recording unit 111 which is the same as the recording unit 11 of FIG. 1; a displaying unit 112 which is the same as the displaying unit 12 of FIG. 1; an image processing unit 114 which is the same as the image processing unit 14 of FIG. 1; an operation unit 115 which has a release button and a selection button (not shown in the drawing) and accepts various instructions from a user; and a controlling unit 116 collectively controlling each of the units. The controlling unit 116 can obtain the same effect as in the present embodiment by carrying out a part of or the whole processing of the flowchart shown in FIG. 2 for an editing object of the moving image generated by the image capturing unit 101.

Further, an image editing program for carrying out a part of or the whole processing of the flowchart shown in FIG. 2 is effective as a specific aspect of the present invention. This image editing program may be one that is recorded in a medium, or one that is recorded in a server on the Internet and that can be downloaded via the Internet.

The many features and advantages of the embodiments are apparent from the detailed specification and, thus, it is intended by the appended claims to cover all such features and advantages of the embodiments that fall within the true spirit and scope thereof. Further, since numerous modifications and changes will be readily occur to those skilled in the art, it is not desired to limit the inventive embodiments to the exact construction and operation illustrated and described, and accordingly all suitable modifications and equivalents may be resorted to, falling within the scope thereof.

1. An image editing apparatus, comprising:
a selecting unit selecting any frame from among a plurality of frames forming a moving image to be edited according to an instruction from a user;
an accepting unit accepting designation of the user regarding an area to be edited and editing content for the any frame;
an extracting unit extracting the area to be edited for each of the frames forming the moving image; and
a calculating unit calculating, for each of the frames forming the moving image, a control value to be used for editing the area in each frame based on a difference between previously or subsequently continuing frames and the editing content.

2. The image editing apparatus according to claim 1, further comprising:
an obtaining unit obtaining an image capturing condition at a time of image capturing of the moving image, wherein
the calculating unit calculates the control value by taking the image capturing condition into account.

3. The image editing apparatus according to claim 1, further comprising:
a detecting unit detecting a gradient of a main object in the moving image, wherein
the extracting unit extracts the area by taking the gradient into account.

4. The image editing apparatus according to claim 1, further comprising:
a detecting unit detecting a gradient of a main object in the moving image, wherein
the calculating unit calculates the control value by taking the gradient into account.

5. The image editing apparatus according to claim 1, further comprising:
an editing unit performing editing for each of the frames forming the moving image according to the control value calculated by the calculating unit.

6. An image editing apparatus, comprising:
a selecting unit selecting any frame from among a plurality of frames forming a moving image to be edited according to an instruction from a user;
an accepting unit accepting designation of the user regarding an area to be edited and editing content for the any frame;
an extracting unit extracting the area to be edited for each of the frames forming the moving image; and
a calculating unit calculating, for each of the frames making up the moving image, a control value to be used for editing the area in each frame based on a result of editing provided to the any frame according to the editing content.

7. The image editing apparatus according to claim 6, further comprising:
an obtaining unit obtaining an image capturing condition at a time of image capturing of the moving image, wherein
the calculating unit calculates the control value by taking the image capturing condition into account.

8. The image editing apparatus according to claim 6, further comprising:
a detecting unit detecting a gradient of a main object in the moving image, wherein
the extracting unit extracts the area by taking the gradient into account.

9. The image editing apparatus according to claim 6, further comprising:
a detecting unit detecting a gradient of a main object in the moving image, wherein
the calculating unit calculates the control value by taking the gradient into account.

10. The image editing apparatus according to claim 6, further comprising:
an editing unit performing editing for each of the frames forming the moving image according to the control value calculated by the calculating unit.

11. An image capturing apparatus, comprising:
an image capturing unit capturing an image of an object and generating a moving image;
a selecting unit selecting any frame from among a plurality of frames forming the moving image generated by the image capturing unit according to an instruction from a user;
an accepting unit accepting designation of the user regarding an area to be edited and editing content for the any frame;
an extracting unit extracting the area to be edited for each of the frames forming the moving image generated by the image capturing unit; and
a calculating unit calculating, for each of the frames forming the moving image generated by the image capturing unit, a control value to be used for editing the area in each frame based on a difference between previously or subsequently continuing frames and the editing content.

12. An image capturing apparatus, comprising:
an image capturing unit capturing an image of an object and generating a moving image;
a selecting unit selecting any frame from among a plurality of frames forming the moving image generated by the image capturing unit according to an instruction from a user;
an accepting unit accepting designation of the user regarding an area to be edited and editing content for the any frame;
an extracting unit extracting the area to be edited for each of the frames forming the moving image generated by the image capturing unit; and
a calculating unit calculating, for each of the frames forming the moving image generated by the image capturing unit, a control value to be used for editing the area in each frame based on a result of editing provided to the any frame according to the editing content.

13. A computer-readable non-transitory medium storing an image editing program, causing a computer to perform the functions of:
selecting any frame from among a plurality of frames forming a moving image to be edited according to an instruction from a user;
accepting designation of the user regarding an area to be edited and editing content for the any frame;
extracting the area to be edited for each of the frames forming the moving image; and
calculating, for each of the frames forming the moving image, a control value to be used for editing the area in each frame based on a difference between previously or subsequently continuing frames and the editing content.

14. A computer-readable non-transitory medium storing an image editing program, causing a computer to perform the functions of:
selecting any frame from a plurality of frames forming the moving image to be edited according to an instruction from a user;
accepting designation of the user regarding an area to be edited and editing content for the any frame;
extracting the area to be edited for each of the frames forming the moving image; and
calculating, for each of the frames forming the moving image, a control value to be used for editing the area in each frame based on a result of editing provided to the any frame according to the editing content.
